(19) United States
(12) Patent Application Publication
(10) Pub. No.: US 2006/0143549 A1
(43) Pub. Date: Jun. 29, 2006

(54) Method and Apparatus for Measuring Bit Error Rate (BER) of Tuner

(75) Inventors: Akira Yasumoto, Yokohama-shi (JP); Susuma Akada, Yokohama-shi (JP); Minoru Nishiyama, Yokohama-shi (JP)

Correspondence Address: FISH & RICHARDSON P.C., P.O. BOX 1022, MINNEAPOLIS, MN, 55440-1022, US

(73) Assignee: Leader Electronics Corporation, Yokohama-shi (JP)

(21) Appl. No.: 11/275,313

(22) Filed: Dec. 22, 2005

(30) Foreign Application Priority Data
Dec. 27, 2004 (JP) 2004-376096

(51) Int. Cl. G06F 11/00

(52) U.S. Cl. 714/704

(57) ABSTRACT

A bit error rate (BER) measuring apparatus is provided for measuring BER of an out-of-band tuner. The BER measuring apparatus generates a test signal for measuring the BER of the out-of-band tuner using a transport stream including a pseudo-random bit string (PRBS). In one embodiment, the BER measuring apparatus comprises a BER test signal generator that generates the test signal which includes a transport stream for transmission. The BER measuring apparatus also comprises a BER detector that detects the BER from a received test signal generated by the tuner in response to the test signal from the BER test signal generator. In one embodiment, the test signal generator comprises a PRBS generator that generates a first PRBS, and a transport stream framing circuit that frames the first PRBS into a transport stream form to generate the transport stream for transmission.

### BACKGROUND

This application claims priority based on Japanese Patent application No. 2004-376096 entitled “Method And Apparatus For Measuring Bit Error Rate (BER) Of Tuner”, which was filed on Dec. 27, 2004, and the disclosure of which, including the specification, drawings and claims is incorporated herein, by reference, in its entirety.

Disclosed embodiments relate to bit error rate (BER) measurement, and more particularly, to a method and apparatus for measuring a BER of a tuner, such as a digital broadcasting tuner, and the like.

U.S. Digital Television Standard, Revision B A/53B provides a plurality of in-band channels within a frequency range of 57 MHz to 870 MHz, and one out-of-band channel within a frequency range of 70 MHz to 130 MHz. Accordingly, digital broadcasting tuners designed for use in the U.S. typically comprise both an in-band tuner and an out-of-band tuner. In measuring a bit error rate (BER) of a tuner comprising both an in-band and an out-of-band tuner, a test signal in the form of a transport stream (TS), and including a pseudo random bit string (PRBS), is used. For measuring a BER of the in-band tuner a test signal comprising a transport stream (TS) is sufficient, since this signal transmission form is uniformly used for in-band tuners. However, no such uniform signal transmission form exists for out-of-band tuners. Thus, for measuring a BER of the out-of-band tuner it is conventional to use a PRBS as a test signal (see Kikusui Knowledge Plaza, “About Bit Error Rate Meter KBM6010,” Kikusui Electronics Corp., searched on Dec. 1, 2004 on the Internet and found at URL: http://www.kikusui.co.jp/knowledgeplaza/BER_meter/BER_meter_j.html)

### SUMMARY

The following embodiments and aspects are described and illustrated in conjunction with systems, tools and methods that are intended to be exemplary and illustrative, and should not be taken as limiting in scope.

According to one aspect, in a BER measuring method a transport stream including a pseudo-random bit string (PRBS) is used to generate a test signal for measuring a BER for an out-of-band tuner.

According to another aspect, the BER measuring method may include the steps of: generating a test signal including a transport stream for transmission; supplying the test signal to the tuner; and detecting a BER from a received test signal which is generated by the tuner in response to the test signal. In this aspect, the step of generating a test signal may include the steps of generating a first PRBS, and framing the first PRBS into a transport stream to generate the transport stream for transmission, wherein the test signal includes the transport stream for transmission. Alternatively, the step of generating a test signal may include the step of reading data for generating the test signal from a memory which stores the data for generating the test signal. Also, the step of detecting a BER may include the step of comparing a received transport stream detected in the received test signal with a reference transport stream to generate a bit error signal when a bit error is detected.

According to a further aspect, a BER measuring apparatus comprises a BER test signal generator that uses a transport stream including a PRBS to generate a test signal for measuring a BER of an out-of-band tuner.

According to a yet further aspect, the BER measuring apparatus may further include said BER test signal generator that generates the test signal including a transport stream for transmission, and supplying the test signal to the tuner, and a BER detector that detects the BER from a received test signal which is generated by the tuner in response to the test signal.

According to a still further aspect, the test signal generator may include a PRBS generator that generates a first PRBS, and a transport stream framing circuit that frames the first PRBS into a transport stream form to generate the transport stream for transmission. Alternatively, the test signal generator may include a memory that stores data for generating the test signal, and a controller that reads the data from the memory to generate the test signal. Also, the BER detector may include a transport stream comparator that compares a received transport stream detected from the received test signal with a reference transport stream to generate a bit error signal when a bit error is detected, and an error counter that counts the bit error signal.

According to another aspect, an apparatus for measuring a BER of a digital broadcasting tuner, uses a transport stream including a PRBS as a test signal for measuring a BER of both an in-band tuner and an out-of-band tuner included in the digital broadcasting tuner.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a block diagram illustrating a bit error rate (BER) measuring apparatus according to a first embodiment;

FIG. 2 is a block diagram illustrating a digital broadcasting tuner 1 intended for a measurement made by the BER measuring apparatus A of FIG. 1;

FIG. 3 is a block diagram illustrating a BER measuring apparatus in one embodiment which is implemented in a more specific manner than the embodiment of FIG. 1;

FIG. 4 is a diagram showing a format for MPEG-2 TS (transport stream);

FIG. 5 is a block diagram illustrating in greater detail a BER detector shown in FIG. 3; and

FIG. 6 is a block diagram illustrating another embodiment of a test signal generator shown in FIG. 3.

### DETAILED DESCRIPTION

Some embodiments will now be described in detail with reference to the accompanying drawings.

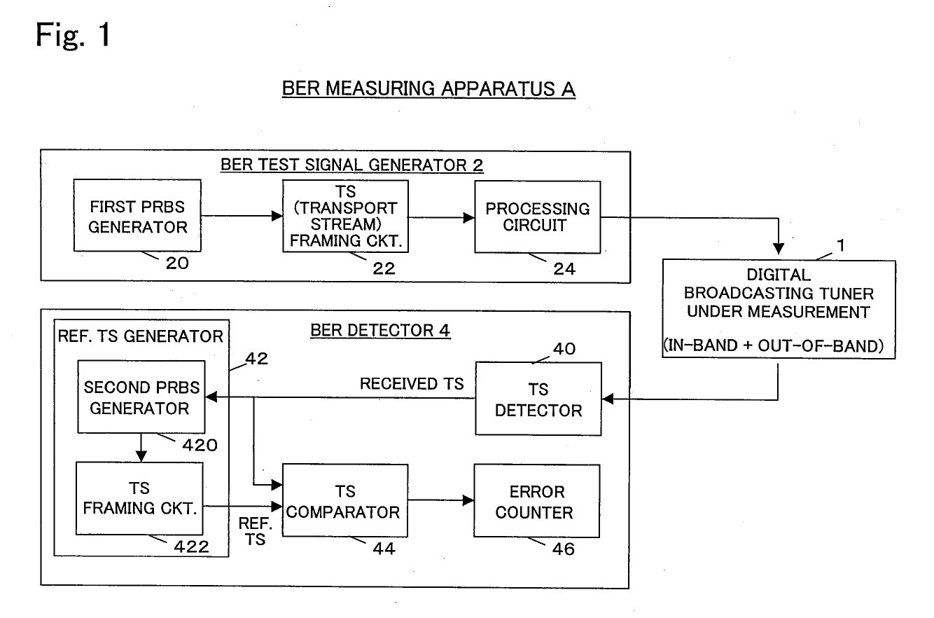

FIG. 1 illustrates in block diagram form a bit error rate (BER) measuring apparatus A according to one embodiment. This BER measuring apparatus A comprises a BER test signal generator 2 and a BER detector 4, as illustrated, for measuring the BER of an out-of-band tuner section in a digital broadcasting tuner 1 under measurement. The test signal generator 2 comprises a first pseudo random bit string (PRBS) generator 20, an MPEG-2 TS (transport stream) framing circuit 22, and a processing circuit 24. The BER detector 4 in turn comprises a TS (transport stream) detector 40, a reference TS generator 42, a TS comparator 44, and an error counter 46.

Specifically, the digital broadcasting tuner 1 comprises an in-band tuner and an out-of-band tuner, and it is the out-of-band tuner that is intended to be the object for measurements made by the BER measuring apparatus A of this embodiment. For measuring the BER of the out-of-band tuner, the PRBS generator 20, which comprises a known arbitrary circuit for generating PRBS, generates, for example, a bit string in a pattern of PN23. The generated PRBS is coupled to the input of the TS framing circuit 22 which generates a TS packet by incorporating the PRBS into the data field of the TS packet. The TS framing circuit 22 can generate, as required, null packets which include null data. The generated TS packet is coupled to the input of the processing circuit 24 which performs processing required for applying the TS packet to the tuner 1; for example, for one or both of modulation and noise addition. If a frequency conversion is also required for applying the TS packet to the tuner, the processing circuit 24 performs this processing as well. It should be noted that the noise addition is performed to provide a C/N (carrier/noise) ratio. A test signal generated in the foregoing manner is applied to an input of the out-of-band tuner in the tuner 1, and the out-of-band tuner generates a received output in response to the applied test signal.

At the BER detector 4, which has an input for the received output generated from the out-of-band tuner, the received output is input to the TS detector 40 which detects a received transport stream from the reception output, and supplies the received transport stream detected thereby to the input of the reference TS generator 42. The reference TS generator 42 comprises a second PRBS generator 420 and a TS framing circuit 422. Specifically, the PRBS generator 420, which receives the received transport stream, internally generates a second or a new PRBS having the same data generation sequence as that generated by the PRBS generator 20 within the test signal generator 2 (for example, a PN code in the same PN23 pattern as the PRBS of the PRBS generator), and synchronizes the generated new PRBS with the PRBS included in the received transport stream, such that a check can be made as to the presence or absence of bit errors. Next, the TS framing circuit 422, which receives the synchronized PRBS, comprises a circuit similar to the TS framing circuit 22 within the test signal generator 2, and generates another transport stream by incorporating the received PRBS in the data field of the transport stream. This transport stream defines a reference transport stream used to determine bit errors in the received transport stream, and is the same as the transport stream generated by the TS framing circuit 22 of the test signal generator 2. The TS comparator 44, which receives the received transport stream and reference transport stream, may be implemented by an arbitrary combination of shift registers and gate circuits, and compares the received transport stream with the reference transport stream on a bit-by-bit basis, and generates a bit error signal at its output when it detects a discrepancy. Specifically, the comparator 44 can detect bit errors in the overall transport stream by comparing not only the PRBS included in the transport stream but also the remaining fields of the transport stream. For example, the bit error rate can be measured with respect to the occurrence of a variety of errors, including errors occurring in a packet header, by detecting bit errors in the overall transport stream. The error counter 46, which has an input connected to the output of the TS comparator 44, counts bit error signals received from the comparator 44. The result of the counting is processed by a circuit, not shown, to calculate the BER.

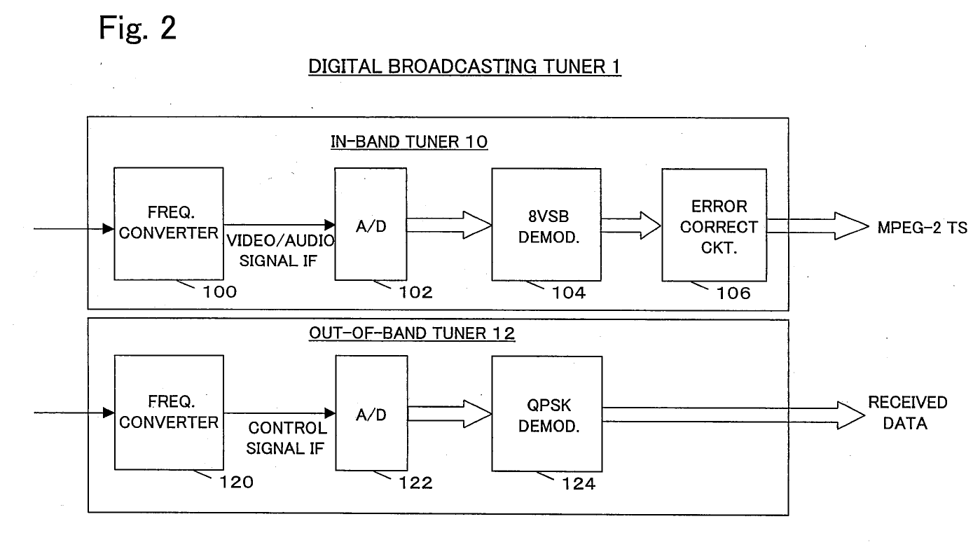

Referring now to FIG. 2, the digital broadcasting tuner 1, which is intended for measurements made by the BER measuring apparatus A of FIG. 1, will be described in detail. As illustrated, the digital broadcasting tuner 1 includes an in-band tuner 10 and an out-of-band tuner 12. The in-band tuner 10 comprises a frequency converter 100, an analog-to-digital (A/D) converter 102, an 8VSB demodulator 104, and an error correcting circuit 106. The out-of-band tuner 12 in turn comprises a frequency converter 120, an analog-to-digital (A/D) converter 122, and a QPSK demodulator 124.

Specifically, in the in-band tuner 10, the frequency converter 100 converts the frequency of an RF input received on an in-band channel to generate an IF version of video and audio signals at its output. The video and audio IF signals are next converted to a digital form by an A/D converter 102. The digitized IF signals are demodulated by the next 8VSB demodulator 104 to generate a transport stream in the baseband. Next, the demodulated transport stream is corrected for errors by the error correcting circuit 106, and then output at a tuner output as MPEG-2TS. In the out-of-band tuner 12, on the other hand, an RF input received on an out-of-band channel is frequency-converted by the frequency converter 120 to generate an IF signal (related to a control signal) which is then converted by the A/D converter 122 from analog to digital form. Next, the digitized IF signal is demodulated by the QPSK demodulator 124 to generate received data in the baseband, i.e., a control signal at its output. In this way, since data is transmitted in the form of a transport stream (TS) on the in-band channel, the tuner 10 outputs data in the TS form. On the other hand, since data transmitted on the out-of-band channel is not defined by any particular form or format, signals can be transmitted in any form or format, so that the tuner 12 outputs a detected signal, as it is, in the same form as a received signal, as received data. Therefore, when data is transmitted in the TS format on the out-of-band channel, the output of the out-of-band tuner 12 will have the TS format.

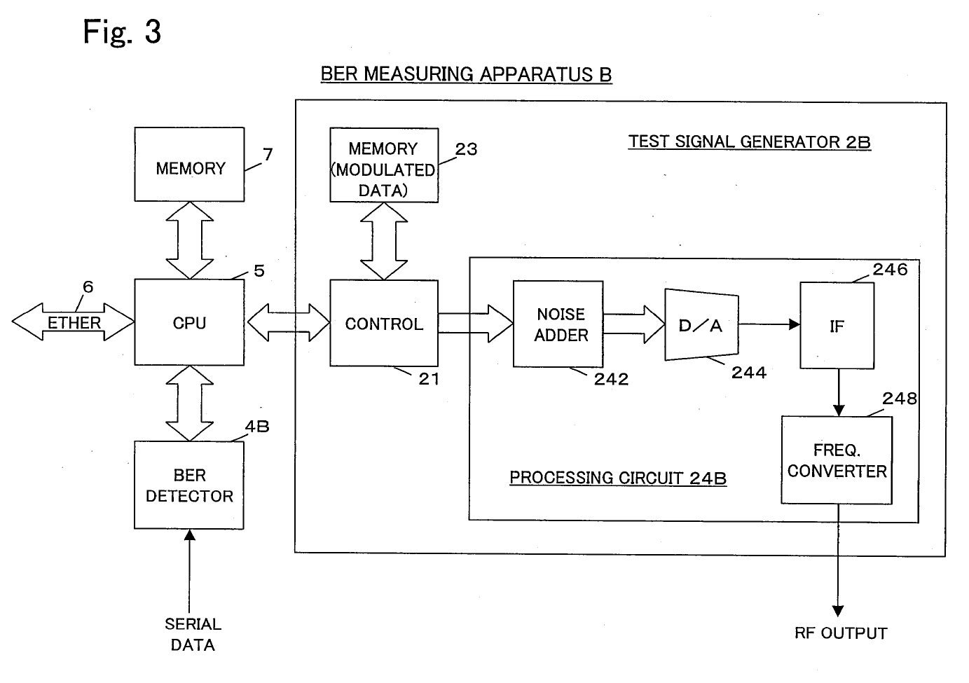

Referring next to FIG. 3, a BER measuring apparatus B in one embodiment is a more specific version of the embodiment in FIG. 1. As can be seen, elements in FIG. 3 corresponding to those in FIG. 1 are denoted by the same reference numerals, respectively, including a suffix “B”. As illustrated, the BER measuring apparatus B comprises a central processing unit (CPU) 5, a memory 7, a test signal generator 2B, and a BER detector 4B. The test signal generator 2B in turn comprises a memory 23, a controller 21 for input/output control of the memory 23, and a processing circuit 24B. Further, the processing circuit 23B comprises a noise adder 242, a digital-to-analog (D/A) converter 244, an IF circuit 246, and a frequency converter 248.

Specifically, the CPU 5 is connected to the memory 7, controller 21, and BER detector 4B through a bus, and is also connected to an external device through Ethernet (ETHER) 6. The memory 7 stores an operating system, programs, data and the like for the CPU 5 to control operations (a variety of operations, for example, read/write of modulated data used to generate the test signal, generation of the test signal, processing of the result of BER detection, and the like) of a variety of circuits within the BER measuring apparatus B (for example, the test signal generator 2B and BER detector 4B). The CPU 5 can also receive the modulated data for storage in the memory 23, later described, through the Ethernet 6. The CPU 5 can further generate an output about the BER measurement based on the result of a detection received by the BER detector 4B. Here, the modulated data stored in the memory 23, which constitutes the test signal, is produced by framing PRBS into an MPEG-2 TS form, and applying a modulation used on the out-of-band channel (i.e., the QPSK modulation) to the resulting transport stream.

The CPU 5 is also connected to the memory 23 and processing circuit 24B through the controller 21 for generation of the test signal. The CPU 5 can receive the modulated data from an external source through the Ethernet 6; and the controller 21 can write the modulated data from the CPU 5 into the memory 23. The CPU 5 also supplies the controller 21 with instructions for controlling the operation of test signal generation (for example, a generation start instruction, a generation stop instruction and the like), and settings related to the test signal (for example, a data rate for the test signal, addition of null packets required to match the signal data rate with the communication rate on a transmission channel, designation of a modulation scheme, and the like). Upon receipt of a test signal generating operation start instruction from the CPU 5, the controller 21 reads modulated data from the memory 23, and generates a BER test signal by using the modulated data in accordance with settings received from the CPU 5. This test signal consists of a pair of I and Q signals, and is supplied to the processing circuit 24B.

Next, the noise adder 242, which receives the thus generated test signal, also receives a specified value for the C/N ratio from the CPU 5 through the controller 21, and then adds noise of such a magnitude that results in the specified C/N ratio. The added noise used herein may be known white noise, for example, a PN node. Next, the noise-added test signal is converted to an analog form by the D/A converter 244, converted to an IF frequency (140 MHz) by the IF circuit 246, and frequency-converted to an RF frequency (70-130 MHz) by the frequency converter 248. The test signal thus generated is supplied to the input of the out-of-band tuner 12 in the digital broadcasting tuner 1 illustrated in FIG. 2.

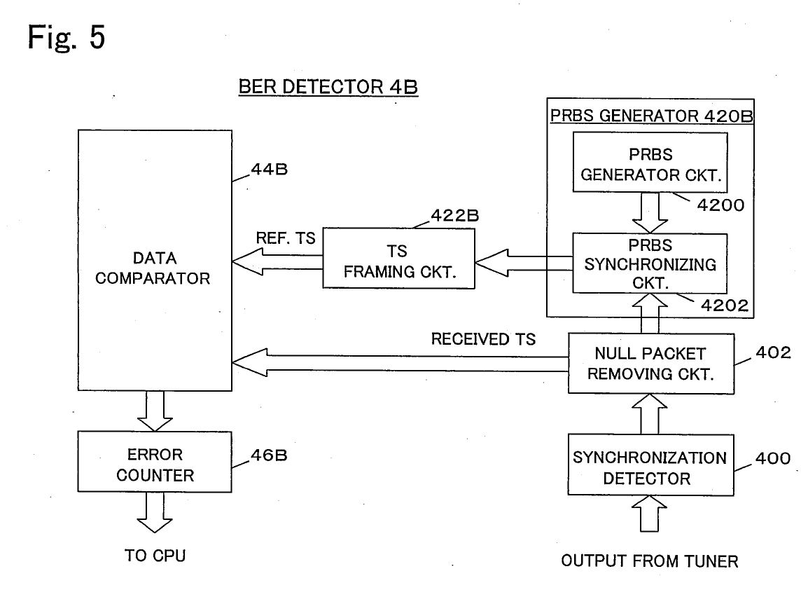

A serial data output, i.e., received transport stream generated by the out-of-band tuner 12 supplied with the test signal, is received by the BER detector 4B which has the input coupled to the output of the tuner 1. The detector 4B compares the received transport stream with the reference transport stream for the detection of bit errors, and supplies the CPU 5 with the result of the detection. The CPU 5 calculates a bit error rate in specified units (for example, in units of TS or time) based on the result of the detection, and outputs (for example, displays) the result of the calculation. The BER detector 4B will be described in detail later with reference to FIG. 5.

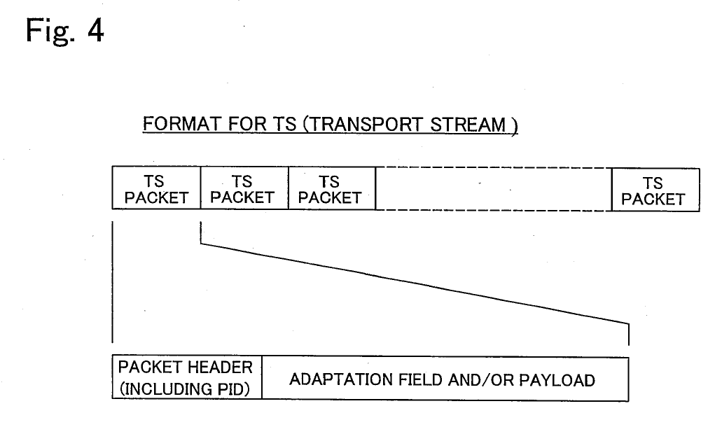

Now, referring to FIG. 4, the structure of the MPEG-2 TS (transport stream) will be described. As illustrated, the transport stream comprises a collection of multiple TS packets. Each TS packet has a fixed length of 188 bytes, and is composed of a packet header, and one or both of an adaptation field and a payload. The packet header includes a packet identifier (PID) and a variety of flags. Particularly, in this embodiment, the packet header includes the value of “47” which indicates that this is a TS packet. The PID identifier also indicates the type of the associated packet, for example, a null packet or a packet including valid data. In this embodiment, a PRBS is incorporated in the payload, i.e., data field or portion. Since the remaining fields of the transport stream do not directly relate to the embodiment, description of them is omitted. Details of the transport stream are as defined in the MPEG-2 standard, the contents of which are incorporated herein by reference.

Referring next to FIG. 5, the BER detector 4B shown in FIG. 3 will be described in detail. As can be seen, elements in FIG. 5 corresponding to those in FIG. 1 are denoted by the same reference numerals including a suffix “B”. As illustrated, the BER detector 4B comprises a synchronization detector 400, a null packet removing circuit 402, a PRBS generator 420B, a TS framing circuit 422B, a data comparator 44B, and an error counter 46B. Further, the PRBS generator 420B comprises a PRBS generator circuit 4200, and a PRBS synchronizing circuit 4202.

Specifically, the synchronization detector 400, which receives serial data from the tuner 1, comprises circuitry including a shift register and a decoder. The synchronization detector 400 detects “47” included in packet headers in the tuner output, and outputs byte by byte a single TS packet which begins with “47” when “47” is detected. The null packet removing circuit 402 , which comprises circuitry including a shift register and a decoder, receives the output of the synchronization detector 400. The null packet removing circuit 402 detects the packet identifier (PID), and discards the TS packet when the PID indicates that the TS packet is a null packet. In this way, the null packet removing circuit 402 supplies the data comparator 44 and PRBS generator 420B with the transport stream including TS packets other than null packets as a received transport stream.

The PRBS generator 420B, which receives the received transport stream, generates a PRBS in the same data generation sequence as the PRBS contained in the modulated data stored in the memory 23 of the test signal generator 2B. The PRBS synchronizing circuit 4202, which receives the generated PRBS, comprises circuitry including a shift register and a decoder. The synchronizing circuit 4202 synchronizes the received PRBS to the received transport stream from the null packet removing circuit 402. Specifically, the synchronizing circuit 4202 forces the PRBS generator circuit 4200 to generate a number of bits of PRBS, which are placed in the shift register, and then forces the PRBS generator circuit 4200 to stop the operation. Then, the PRBS synchronizing circuit 4202 sequentially compares the bit string placed in the shift register with incoming received transport stream, and forces the PRBS generator circuit 4200 to resume the operation when it detects the number of matching bits in both, thereby generating a PRBS synchronized with the PRBS in the received transport stream. In the received transport stream from the null packet removing circuit 402, the PRBS portion is fragmented by the packet header and the like, so that the PRBS synchronizing circuit 4202 repeats the synchronizing operation each time the PRBS portion is fragmented. The PRBS generator 420B which performs the foregoing operation is known in the art, so that those skilled in the art can employ an arbitrary known circuit configuration therefor. The TS framing circuit 422B, which receives the PRBS generated in the foregoing manner, frames the PRBS into a transport stream form to generate a reference transport stream which is supplied to the data comparator 44B.

Next, the data comparator 44B, which receives the received transport stream and reference transport stream, comprises circuitry including a shift register and a decoder. The data comparator 44B compares the received transport stream with the reference transport stream on a bit-by-bit basis, and generates a bit error signal at its output each time it detects a discrepancy. The error counter 46B has an input connected to the output of the data comparator 44B, and therefore counts the number of the bit error signals supplied from the comparator 44B. The result of the counting is supplied to the CPU 5. The CPU 5 calculates a bit error rate in units based on the result of the counting, in the same manner as described above. In this way, the BER measuring apparatus B of this embodiment measures the BER of the out-of-band tuner using the test signal in the TS format.

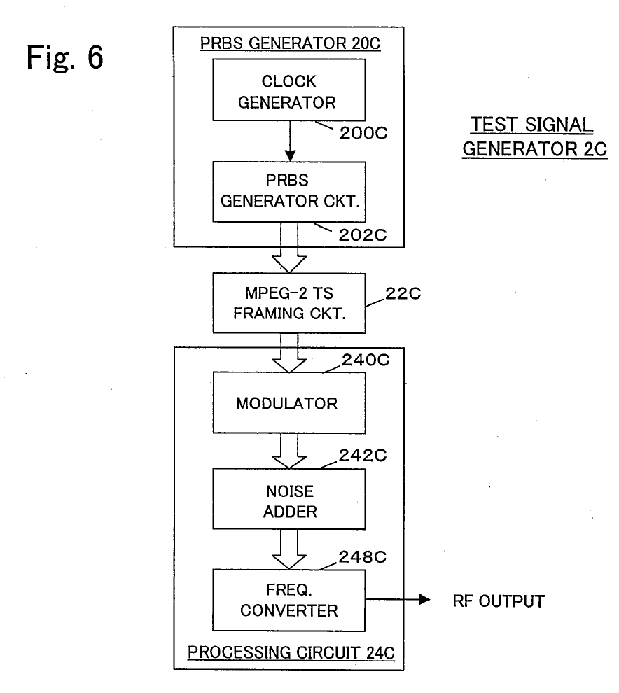

Referring next to FIG. 6, a test signal generator 2C, now described, is another embodiment of the test signal generator 2B shown in FIG. 3. Elements in FIG. 6 corresponding to those in FIG. 1 or FIG. 3 are denoted by the same reference numerals including a suffix “C”. As illustrated, the test signal generator 2C comprises a PRBS generator 20C, a TS framing circuit 22C, and a processing circuit 24C. Further, the PRBS generator 20C comprises a clock generator 200C and a PRBS generator circuit 202C. The processing circuit 24C in turn comprises a modulator 240C, a noise adder 242C, and a frequency converter 248C. The test signal generator 2C illustrated in FIG. 6 differs from that illustrated in FIG. 3 in that the embodiment of FIG. 6 comprises the PRBS generator 20C, TS framing circuit 22C, and modulator 240C instead of the memory 23 in FIG. 3. Specifically, the embodiment of FIG. 6 employs individual hardware components for generating, framing, and modulating the PRBS, thereby generating the same test signal as that generated by reading the modulated data stored in the memory 23 in the embodiment of FIG. 3. The remaining aspects are basically the same in configuration, though FIG. 6 illustrates the configuration in a simpler manner than FIG. 3, and therefore further description is omitted.

According to the BER measuring apparatus of the foregoing embodiment, the BER can be measured for the out-of-band tuner using the TS-based test signal, and moreover, the BER can also be measured for the in-band tuner section using the TS-based test signal. In this case, the test signal modulator or processing circuit may modulate the test signal or convert the frequency thereof in conformity to a modulation scheme and a frequency band used for the in-band channel. Alternatively, the memory 23 in FIG. 3 may store data resulting from such a modulation in conformity to the in-band channel. By doing so, a single BER measuring apparatus can measure the BER for both the out-of-band tuner and in-band tuner sections.

While a number of exemplary aspects and embodiments have been discussed above, it will be readily apparent to those skilled in the art that a variety of modifications, permutations, additions and sub-combinations thereof are possible. It is therefore intended that the following appended claims and claims hereafter introduced are interpreted to include all such modifications, permutations, additions and sub-combinations as are within the true spirit and scope of the invention.

What is claimed is:

1. A bit error rate measuring method comprising the steps of:
using a transport stream including a pseudo-random bit string to generate a test signal; and
measuring a bit error rate of an out-of-band tuner using the test signal.

2. A bit error rate measuring method according to claim 1, wherein:
said out-of-band tuner is included in a digital broadcasting tuner, said digital broadcasting tuner also including an in-band tuner, and
said transport stream including the pseudo-random bit string is also used to generate a test signal for measuring a bit error rate of said in-band tuner.

3. A bit error rate measuring method according to claim 1, further comprising the steps of:
generating the test signal including a transport stream for transmission, said test signal being supplied to said tuner; and
detecting the bit error rate from a received test signal, said received test signal being generated by said tuner in response to the test signal.

4. A bit error rate measuring method according to claim 3, wherein said step of generating a test signal includes the steps of:
generating a first pseudo-random bit string; and
framing the first pseudo-random bit string into a transport stream form to generate the transport stream for transmission, said test signal including the transport stream for transmission.

5. A bit error rate measuring method according to claim 3, wherein said step of generating a test signal includes the step of:
reading data for generating the test signal from a memory which stores the data for generating the test signal.

6. A bit error rate measuring method according to claim 3, wherein said step of detecting a bit error rate includes the step of:
comparing a received transport stream detected from the received test signal with a reference transport stream to generate a bit error signal when a bit error is detected.

7. A bit error rate measuring apparatus comprising:
a bit error rate test signal generator that uses a transport stream including a pseudo-random bit string to generate a test signal for measuring a bit error rate of an out-of-band tuner.

8. A bit error rate measuring apparatus according to claim 7, wherein:
said apparatus measures bit errors occurring in the overall transport stream to provide the bit error rate.

9. A bit error rate measuring apparatus according to claim 7, wherein:
said transport stream has a data portion including the pseudo-random bit string.

10. A bit error rate measuring apparatus according to claim 7, wherein:
said out-of-band tuner is included in a digital broadcasting tuner,
said digital broadcasting tuner also includes an in-band tuner, and
said transport stream including the pseudo-random bit string is also used to generate a test signal for measuring a bit error rate of said in-band tuner.

11. A bit error rate measuring apparatus according to claim 7, comprising:
said bit error rate test signal generator that generates the test signal including a transport stream for transmission, said test signal being supplied to said tuner; and
a bit error rate detector that detects the bit error rate from a received test signal, said received test signal being generated by said tuner in response to the test signal.

12. A bit error rate measuring apparatus according to claim 11, wherein said test signal generator includes:
a pseudo-random bit string generator that generates a first pseudo-random bit string; and
a transport stream framing circuit that frames the first pseudo-random bit string into a transport stream form to generate the transport stream for transmission.

13. A bit error rate measuring apparatus according to claim 12, wherein said test signal generator further includes:
a processing circuit that modulates the test signal and/or adding noise to the test signal.

14. A bit error rate measuring apparatus according to claim 11, wherein said test signal generator includes:
a memory that stores data for generating the test signal; and
a controller that reads the data from said memory to generate the test signal.

15. A bit error rate measuring apparatus according to claim 14, wherein:
said test signal includes a modulated version of the transport stream for transmission including a first pseudo-random bit string.

16. A bit error rate measuring apparatus according to claim 11, wherein:
said test signal includes added noise.

17. A bit error rate measuring apparatus according to claim 16, wherein:
said noise is used to form a C/N ratio.

18. A bit error rate measuring apparatus according to claim 11, wherein said bit error rate detector includes:
a transport stream comparator that compares a received transport stream detected from the received test signal with a reference transport stream to generate a bit error signal when a bit error is detected; and
an error counter that counts the bit error signal.

19. A bit error rate measuring apparatus according to claim 18, wherein:
said transport stream for transmission includes a first pseudo-random bit string,
said bit error rate detector further includes a reference transport stream generator that generates the reference transport stream, and
said reference transport stream generator includes:
a pseudo-random bit string generator that generates a second pseudo-random bit string, said second pseudo random bit string having a data generating sequence consistent with the first pseudo-random bit string included in the transport stream for transmission; and
a transport stream framing circuit that frames the second pseudo-random bit string into a transport stream form to generate the reference transport stream.

20. A bit error rate measuring apparatus according to claim 19, wherein said second pseudo-random bit string generator includes:
a pseudo-random bit string generator circuit that generates the second pseudo-random bit string; and
a synchronizing circuit that synchronizes the second pseudo-random bit string to the first pseudo-random bit string included in the transport stream for transmission.

21. An apparatus for measuring a bit error rate of a digital broadcasting tuner, comprising:
a bit error rate test signal generator that uses a transport stream including a pseudo-random bit string as a test signal for measuring a bit error rate of both an in-band tuner and an out-of-band tuner included in said digital broadcasting tuner.

22. A bit error rate measuring apparatus comprising:
means for using a transport stream including a pseudo-random bit string to generate a test signal for measuring a bit error rate of an out-of-band tuner.
